(19) United States
(12) Patent Application Publication
(10) Pub. No.: US 2011/0281179 A1
(43) Pub. Date: Nov. 17, 2011

(54) NON-AQUEOUS ELECTROLYTIC SOLUTION, AND LITHIUM BATTERY COMPRISING SAME

(75) Inventor: Koji Abe, Yamaguchi (JP)

(73) Assignee: UBE INDUSTRIES, LTD., Yamaguchi (JP)

(21) Appl. No.: 13/130,216

(22) PCT Filed: Nov. 10, 2009
(86) PCT No.: PCT/JP2009/069136

§ 371 Date: Jul. 26, 2011

(30) Foreign Application Priority Data
Nov. 21, 2008 (JP) 2008-298636

(51) Int. Cl. H01M 10/056; H01M 10/052

(52) U.S. Cl. 429/332; 429/200

(57) ABSTRACT

Provided are a nonaqueous electrolytic solution including an electrolyte salt dissolved in a nonaqueous solvent, which is characterized by containing a fluorine-containing phenol represented by the following general formula (I) in an amount of from 0.01 to 3% by mass of the nonaqueous electrolytic solution, and is excellent in storage property of a primary battery, cycle property upon use of a secondary battery at a high temperature, and suppressing effect on the generation of a gas during the charged battery storing of the secondary battery, and a lithium battery using the solution.

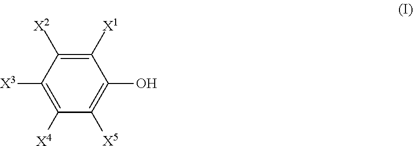

(In the formula, X¹ to X⁵ each independently represent a fluorine atom or a hydrogen atom, and 3 to 5 thereof represent fluorine atoms).

### TECHNICAL FIELD

The present invention relates to a nonaqueous electrolytic solution and a lithium battery using the same.

### BACKGROUND ART

In recent years, a lithium secondary battery has been widely used as a drive power supply for small-size electronic devices such as mobile telephones, notebook-size personal computers and the like, and a power supply for electric vehicles as well as for electric power storage.

The lithium secondary battery is mainly constituted of a positive electrode and a negative electrode containing a material capable of absorbing and releasing lithium, and a nonaqueous electrolytic solution containing a lithium salt. For the nonaqueous electrolytic solution, used are carbonates such as ethylene carbonate (EC), propylene carbonate (PC), etc.

As the negative electrode of the lithium secondary battery, known are metal lithium, and metal compounds (metal elemental substances, oxides, alloys with lithium, etc.) and carbon materials capable of absorbing and releasing lithium. In particular, a nonaqueous electrolytic solution secondary battery using, among carbon materials, a carbon material capable of absorbing and releasing lithium such as coke, graphite (such as artificial graphite or natural graphite) or the like has been widely put into practical use.

Since any such negative electrode material as described above stores and releases lithium and an electron at a low potential similar to that of a lithium metal, the material has the possibility that a large number of solvents undergo reductive decomposition particularly under high temperatures. In addition, irrespective of the kind of the negative electrode material, part of a solvent in the electrolytic solution undergoes reductive decomposition on a negative electrode, and the decomposed product deposits on the surface of the negative electrode to increase the resistance of the electrode. Alternatively, a gas is generated owing to the decomposition of the solvent to swell the battery. Accordingly such solvents decomposition hinders the movement of a lithium ion, thereby causing such a problem that battery characteristics such as high-temperature cycle property worsen.

On the other hand, a material capable of absorbing and releasing lithium such as LiCoO₂, LiMn₂O₄, LiNiO₂, or LiFePO₄ to be used as a positive electrode material has the possibility that a large number of solvents undergo oxidative decomposition because the material stores and releases lithium and an electron at a high voltage of 3.5 V or more with reference to lithium. In addition, irrespective of the kind of the positive electrode material, part of the solvent in the electrolytic solution undergoes oxidative decomposition on a positive electrode, and the decomposed product deposits on the surface of the positive electrode to increase the resistance of the electrode. Alternatively, a gas is generated owing to the decomposition of the solvent to swell the battery. Accordingly such solvents decomposition hinders the movement of a lithium ion, thereby causing such a problem that the battery characteristics such as the high-temperature cycle property worsen.

Patent Reference 1 discloses a nonaqueous electrolyte battery containing, in an electrolyte, such a compound that a first-stage pKa value in an aqueous solution of the compound itself or a conjugate acid thereof is 8.0 or more (e.g., phenol, o-fluorophenol, m-fluorophenol, or p-fluorophenol). The reference describes that in the battery, the electrolyte becomes additionally basic to prevent a positive electrode active material such as lithium nickelate, lithium cobaltate, or spinel-phase lithium manganate as a basic oxide from becoming instable against an acid, thereby exerting an improving effect on lifetime property.

Patent Reference 2 discloses a nonaqueous electrolytic solution battery obtained by adding, to a nonaqueous electrolytic solution, an organic compound having a reversible oxidation-reduction potential at a more electropositive battery potential than a positive electrode potential during full charge such as 2,4-difluorophenol. The reference describes the following. Even when the battery is brought into an overcharged state, an overcharge reaction on an electrode is inhibited, and an increase in the temperature of the battery stops simultaneously with the cut-off of an overcharge current. Accordingly, the battery does not generate heat.

Besides, as a lithium primary battery, for example, there is known a lithium primary battery including manganese dioxide or graphite fluoride as the positive electrode and a lithium metal as the negative electrode, and the lithium primary battery is widely used as having a high energy density. It is desired to inhibit the self-discharge and increase in the internal resistance of the battery during high-temperature storage and to improve the storage property thereof.

Recently, further, as a novel power source for electric vehicles or hybrid electric vehicles, electric storage devices have been developed, for example, a so-called electric double layer capacitor using activated carbon or the like as the electrode from the viewpoint of the output density thereof, and a so-called hybrid capacitor including a combination of the electric storage principle of a lithium ion secondary battery and that of an electric double layer capacitor (an asymmetric capacitor where both the capacity by lithium absorption and release and the electric double layer capacity are utilized) from the viewpoint of both the energy density and the output density thereof; and it is desired to improve the cycle property and the like at high temperatures of these capacitors.
[Patent Reference 1] JP 2000-156245 A
[Patent Reference 2] JP 2000-156243 A

### DISCLOSURE OF THE INVENTION

### Problems that the Invention is to Solve

An object of the present invention is to provide a nonaqueous electrolytic solution excellent in storage property of a primary battery, cycle property upon use of a secondary battery at a high temperature, and suppressing effect on the generation of a gas during the charged secondary battery is charged or stored, and a lithium battery using the solution.

### Means for Solving the Problems

The inventors of the present invention have made detailed investigations on the performance of each of the nonaqueous electrolytic solutions of the above-mentioned prior art. As a result, none of Patent References 1 and 2 described above pays attention to the generation of a gas during charged battery storing at a high temperature and to high-temperature cycle property. Reproductive experiments of the examples of those references have elucidated that the nonaqueous electrolytic solutions have nearly no suppressing effect on the generation of a gas during battery charging or storing at a high temperature, and hence the high-temperature cycle property worsen.

In view of the foregoing, the inventors of the present invention have made extensive studies to solve the above-mentioned problems. As a result, the inventors have found that the addition of a small amount of phenol 3 to 5 hydrogen atoms of which are substituted with fluorine suppresses the generation of a gas during charged battery storing at a high temperature, and hence the high-temperature cycle property can be improved. Further, the inventors have understood that those effects correlate with the pKa value of each compound, and in particular, have found that a compound having a pKa value of from 5 to 7 shows excellent properties. Thus, the inventors have completed the present invention.

That is, the present invention provides the following items (1) and (2).

(1) A nonaqueous electrolytic solution comprising an electrolyte salt dissolved in a nonaqueous solvent, which comprises a fluorine-containing phenol represented by the following general formula (I) in an amount of from 0.01 to 3% by mass of the nonaqueous electrolytic solution:

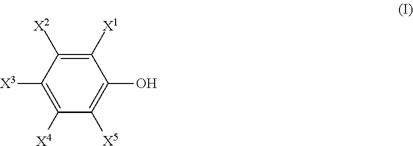

wherein X¹ to X⁵ each independently represent a fluorine atom or a hydrogen atom, and 3 to 5 thereof represent fluorine atoms.

(2) A lithium battery, comprising: a positive electrode; a negative electrode; and a nonaqueous electrolytic solution prepared by dissolving an electrolyte salt in a nonaqueous solvent, wherein the nonaqueous electrolytic solution comprises the fluorine-containing phenol represented by the general formula (I) in an amount of from 0.01 to 3% by mass of the nonaqueous electrolytic solution.

### Advantage of the Invention

According to the present invention, there can be provided a nonaqueous electrolytic solution excellent in storage property of a primary battery, cycle property upon use of a secondary battery at a high temperature, and suppressing effect on the generation of a gas when the charged secondary battery is stored, and a lithium battery using the solution.

### BEST MODE FOR CARRYING OUT THE INVENTION

[Nonaqueous Electrolytic Solution]

A nonaqueous electrolytic solution of the present invention is a nonaqueous electrolytic solution including an electrolyte salt dissolved in a nonaqueous solvent, and is characterized by containing a fluorine-containing phenol represented by the general formula (I) in an amount of from 0.01 to 3% by mass of the nonaqueous electrolytic solution.

[Fluorine-Containing Phenol Represented by General Formula (I)]

The fluorine-containing phenol in the nonaqueous electrolytic solution of the present invention is represented by the following general formula (I).

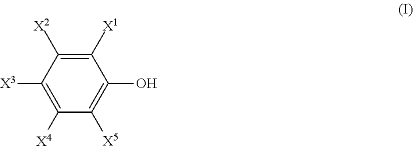

In the general formula (I), X¹ to X⁵ each independently represent a fluorine atom or a hydrogen atom, and 3 to 5 thereof represent fluorine atoms.

That is, the fluorine-containing phenol represented by the general formula (I) is one or more kinds selected from trifluorophenol, tetrafluorophenol, and pentafluorophenol. Specific examples thereof include 2,3,4-trifluorophenol, 2,3,5-trifluorophenol, 2,3,6-trifluorophenol, 2,4,5-trifluorophenol, 2,4,6-trifluorophenol, 3,4,5-trifluorophenol, 2,3,5,6-tetrafluorophenol, and pentafluorophenol.

Of those, preferred is one having a fluorine atom at an ortho-position and/or the para-position relative to the hydroxyl group in the general formula (I), and more preferred is one having a fluorine atom at the para-position.

Of the fluorine-containing phenol represented by the general formula (I), more preferred are tetrafluorophenol and pentafluorophenol, even more preferred are 2,3,5,6-tetrafluorophenol and pentafluorophenol, particularly preferred is pentafluorophenol.

The above-mentioned specific compounds are preferred because the compounds each have high high-temperature cycle property and a high suppressing effect on the generation of a gas during charged battery storing. Although reasons for the foregoing are not necessarily clear, the property and the effect are considered to result from the following reasons.

It has been elucidated that when a battery is stored under a high temperature in a charged state, a basic impurity such as LiOH present in a trace amount in a positive electrode serves as a catalyst to help the decomposition of a nonaqueous solvent such as a cyclic carbonate or a linear carbonate, and hence a CO₂ gas or the like is generated. As shown in Table 1, pentafluorophenol and the like belonging to the fluorine-containing phenol represented by the general formula (I) are acidic compounds having pKa values in a specific range, and the addition of a small amount of the fluorine-containing phenol may result in the formation of a stable surface film through a reaction with LiOH as the impurity present on the surface of the positive electrode. As a result, it may become possible to suppress the generation of a gas during charged battery storing at a high temperature.

In addition, the fluorine-containing phenol is not a strong acid, and is hence nearly free of such an influence that a metal element in a positive electrode active material is eluted. Accordingly, the positive electrode active material does not deteriorate. Further, the fluorine-containing phenol shows excellent high-temperature cycle property probably because of the following reason. The fluorine-containing phenol can decompose on a negative electrode to form a fluorine-containing surface film, and hence the decomposition of the nonaqueous solvent on the negative electrode can be suppressed.

TABLE 1

| Compound | pKa |
|---|---|
| Pentachlorophenol | 4.7 |
| Pentafluorophenol | 5.5 |
| 2,3,5,6-Tetrafluorophenol | 5.5 |
| 2,3,4-Trifluorophenol | 6.0 |
| 2,4-Difluorophenol | 8.4 |
| 4-Fluorophenol | 9.9 |
| Phenol | 10 |

Here, the pKa value is also called an acid dissociation constant, and the pKa can be measured by an ordinary method. For example, the pKa can be determined in accordance with the method described in Experimental Chemistry Seminar 5 “Thermal Measurement and Equilibrium”, p. 460 (edited by the Chemical Society of Japan, published by Maruzen Company, Limited.).

The pKa value of the fluorine-containing phenol is preferably from 5 to 7, more preferably from 5 to 6.5, and still more preferably from 5.3 to 5.7 from the viewpoints of high-temperature cycle property and the suppression of the generation of a gas during charged battery storing.

[Content of Fluorine-Containing Phenol]

In the nonaqueous electrolytic solution of the present invention, when the content of the fluorine-containing phenol represented by the general formula (I) in the nonaqueous electrolytic solution exceeds 3% by mass, a surface film is excessively formed on an electrode, and hence battery characteristics such as high-temperature cycle property may worsen. In addition, when the content is less than 0.01% by mass, a protecting effect on a positive electrode or a negative electrode is not sufficient, and hence the high-temperature cycle property or a suppressing effect on the generation of a gas during charged battery storing cannot be obtained in some cases. Therefore, the content of the compound in the nonaqueous electrolytic solution is 0.01% by mass or more, preferably 0.03% by mass or more, more preferably 0.05% by mass or more, and still more preferably 0.1% by mass or more. In addition, an upper limit for the content is 3% by mass or less, preferably 2% by mass or less, more preferably 1.5% by mass or less, and still more preferably 0.5% by mass or less. When two or more kinds of the fluorine-containing phenols are used in combination, the total content of the phenols preferably falls within the above-mentioned range.

In the nonaqueous electrolytic solution of the present invention, the high-temperature cycle property and the suppressing effect on the generation of a gas during charged battery storing are improved even when the fluorine-containing phenol represented by the general formula (I) in the nonaqueous electrolytic solution is used alone. However, when combined with a nonaqueous solvent, an electrolyte salt, and furthermore, any other additive to be described later, the fluorine-containing phenol exerts such a specific effect that the high-temperature cycle property and the suppressing effect on the generation of a gas during charged battery storing are synergistically improved. Although a reason for the foregoing is not necessarily clear, the specific effect is exerted probably because a mixed surface film containing the fluorine-containing phenol and constitutive elements of the nonaqueous solvent, the electrolyte salt, and furthermore, the other additive, and having high ionic conductivity is formed.

[Nonaqueous Solvent]

The nonaqueous solvent for use in the nonaqueous electrolytic solution of the present invention includes cyclic carbonates, linear carbonates, linear esters, ethers, amides, phosphates, sulfones, lactones, nitriles, S═O bond-containing compounds, aromatic compounds, etc.

The cyclic carbonates include ethylene carbonate (EC), propylene carbonate (PC), butylene carbonate (EC), 4-fluoro-1,3-dioxolan-2-one (FEC), trans or cis-4,5-difluoro-1,3-dioxolan-2-one (hereinafter, the two are collectively referred to as “DFEC”), vinylene carbonate (VC), vinylethylene carbonate (VEC), etc. Of those, from the viewpoints of the high-temperature cycle property and the suppression of the generation of a gas during charged battery storing, one or more kinds selected from EC, PC, and a cyclic carbonate containing a carbon-carbon double bond or fluorine are preferred, and the nonaqueous electrolytic solution particularly preferably contains EC and/or PC, and both of a cyclic carbonate containing a carbon-carbon double bond and a cyclic carbonate containing fluorine. As the carbon-carbon double bond-containing cyclic carbonate, preferred are VC and VEC; and as the fluorine-containing cyclic carbonate, preferred are FEC and DFEC.

One kind of those solvents may be used, but using two or more different kinds as combined is preferred as further improving the high-temperature cycle property or the suppressing effect on the generation of a gas during charged battery storing. Even more preferably, three or more different kinds are combined. Preferred combinations of the cyclic carbonates include EC and PC; EC and VC; EC and VEC; PC and VC; FEC and VC; FEC and EC; FEC and PC; FEC and DFEC; DFEC and EC; DFEC and PC; DFEC and VC; DFEC and VEC; EC and PC and VC; EC and FEC and PC; EC and FEC and VC; EC and VC and VEC; FEC and PC and VC; DFEC and EC and VC; DFEC and PC and VC; FEC and EC and PC and VC; DFEC and EC and PC and VC, etc. Of those combinations, more preferred combinations are EC and VC; FEC and PC; DFEC and PC; EC and FEC and PC; EC and FEC and VC; EC and PC and VC; and EC and VC and VEC, etc.

Not specifically defined, the content of the cyclic carbonate is preferably within a range of from 10 to 40% by volume relative to the total volume of the nonaqueous solvent. When the content is less than 10% by volume, then the electric conductivity of the electrolytic solution may lower, and the internal resistance of the battery may increase; but when more than 40% by volume, then the high-temperature cycle property or the suppressing effect on the generation of a gas during charged battery storing may worsen.

The linear carbonates include asymmetric linear carbonates such as methyl ethyl carbonate (MEC), methyl propyl carbonate, methyl isopropyl carbonate, methyl butyl carbonate, ethyl propyl carbonate, etc.; symmetric linear carbonates such as dimethyl carbonate (DMC), diethyl carbonate (DEC), dipropyl carbonate, dibutyl carbonate, etc. In particular, the nonaqueous electrolytic solution preferably contains the symmetric linear carbonate because the high-temperature cycle property and the suppressing effect on the generation of a gas during charged battery storing tend to be improved, and the symmetric linear carbonate and the asymmetric linear carbonate are more preferably used in combination. The symmetric linear carbonate is particularly preferably diethyl carbonate (DEC).

Although one kind of those linear carbonates may be used, two or more kinds of them are preferably used in combination because the above-mentioned effects are additionally improved.

Not specifically defined, the content of the linear carbonate is preferably within a range of from 60 to 90% by volume relative to the total volume of the nonaqueous solvent. When the content is less than 60% by volume, then the viscosity of the electrolytic solution may increase; but when more than 90% by volume, then the electric conductivity of the electrolytic solution may lower and battery characteristics such as the high-temperature cycle property may worsen. Accordingly, the above range is preferred.

A ratio (volume ratio) “cyclic carbonates:linear carbonates” between the cyclic carbonates and the linear carbonates is preferably from 10:90 to 40:60, more preferably from 15:85 to 35:65, and particularly preferably from 20:80 to 30:70 from the viewpoints of the improvements of the high-temperature cycle property and the suppressing effect on the generation of a gas during charged battery storing.

The linear esters include methyl propionate, ethyl propionate, methyl acetate, ethyl acetate, methyl pivalate, butyl pivalate, hexyl pivalate, octyl pivalate, dimethyl oxalate, ethyl methyl oxalate, diethyl oxalate, etc. The ethers include cyclic ethers such as tetrahydrofuran, 2-methyltetrahydrofuran, 1,3-dioxolane, 1,3-dioxane, 1,4-dioxane, etc.; linear ethers such as 1,2-dimethoxyethane, 1,2-diethoxyethane, 1,2-dibutoxyethane, etc.

The amides include dimethylformamide, etc.; the phosphates include trimethyl phosphate, tributyl phosphate, trioctyl phosphate, etc.; the sulfones include sulfolane, etc.; the lactones include γ-butyrolactone, γ-valerolactone, α-angelicalactone, etc.; the nitriles include acetonitrile, propionitrile, succinonitrile, glutaronitrile, adiponitrile, etc.

Examples of the S═O bond-containing compound include: sultone compounds such as 1,3-propanesultone(PS), 1,3-butanesultone, and 1,4-butanesultone; cyclic sulfite compounds such as ethylene sulfite, hexahydrobenzo[1,3,2]dioxathiolane-2-oxide (also referred to as 1,2-cyclohexanediol cyclic sulfite), and 5-vinyl-hexahydro-1,3,2-benzodioxathiol-2-oxide; disulfonic acid diester compounds such as 1,4-butanediol dimethanesulfonate and 1,3-butanediol dimethanesulfonate; and vinyl sulfone compounds such as divinyl sulfone, 1,2-bis(vinylsulfonyl)ethane, and bis(2-vinylsulfonylethyl)ether.

Examples of the aromatic compounds include aromatic compounds each having a branched alkyl group, such as cyclohexylbenzene, fluorocyclohexylbenzene compounds (including 1-fluoro-2-cyclohexylbenzene, 1-fluoro-3-cyclohexylbenzene, and 1-fluoro-4-cyclohexylbenzene), tert-butylbenzene, tert-amylbenzene, 1-fluoro-4-tert-butylbenzene, and 1,3-di-tert-butylbenzene, and aromatic compounds such as biphenyl, terphenyls (o-, m-, and p-isomers), diphenyl ether, fluorobenzene, difluorobenzene (o-, m-, and p-isomers), 2,4-difluoroanisole, and partially hydrogenated terphenyl (including 1,2-dicyclohexylbenzene, 2-phenylbicyclohexyl, 1,2-diphenylcyclohexane, and o-cyclohexylbiphenyl).

The fluorine-containing phenol represented by the general formula (I) is preferably used in combination with one or more kinds selected from, in particular, the cyclic ethers, the S═O bond-containing compounds, and the aromatic compounds each having a branched alkyl group out of the above-mentioned nonaqueous solvents because the high-temperature cycle property and the suppressing effect on the generation of a gas during charged battery storing are improved. Of those, an S═O bond-containing compound is particularly preferred. When the addition amount of any such compound to be used in combination with the fluorine-containing phenol represented by the general formula (I) exceeds 5% by mass, the high-temperature cycle property may worsen. In addition, when the addition amount is less than 0.05% by mass, an improving effect on the property cannot be sufficiently obtained in some cases. Accordingly, the content is preferably at least 0.05% by mass of the mass of the nonaqueous electrolytic solution, more preferably at least 0.5% by mass. The upper limit of the content is preferably at most 5% by mass, more preferably at most 3% by mass.

In general, the nonaqueous solvents are used as a mixture thereof for attaining the suitable physical properties. Regarding their combinations, for example, there are mentioned combinations of cyclic carbonates alone, combinations of linear carbonates alone, a combination of a cyclic carbonate and a linear carbonate, a combination of a cyclic carbonate, a linear carbonate, and a lactone, a combination of a cyclic carbonate, a linear carbonate, and a linear ester, a combination of a cyclic carbonate, a linear carbonate, and a ether, a combination of a cyclic carbonate, a linear carbonate, and an S═O bond-containing compound, etc.

Of those, preferred is using a nonaqueous solvent of a combination of at least a cyclic carbonate and a linear carbonate, as improving the high-temperature cycle property or the suppressing effect on the generation of a gas during charged battery storing. More specifically, a combination of one or more kinds of cyclic carbonates selected from EC, PC, VC, VEC, and FEC, and one or more kinds of linear carbonates selected from DMC, MEC, and DEC is given.

[Electrolyte Salt]

The electrolyte salt for use in the present invention includes lithium salts such as LiPF₆, LiBF₄, LiClO₄, etc.; linear fluoroalkyl group-containing lithium salts such as LiN(SO₂CF₃)₂, LiN(SO₂C₂F₅)₂, LiCF₃SO₃, LiC(SO₂CF₃)₃, LiPF₄(CF₃)₂, LiPF₃(C₂F₅)₃, LiPF₃ (CF₃)₃, LiPF₃(iso C₃F₇)₃, LiPF₅(iso-C₃F₇), etc.; cyclic fluoroalkylene chain-containing lithium salts such as (CF₂)₂(SO₂)₂NLi, (CF₂)₃(SO₂)₂NLi, etc.; and lithium salts with an anion of an oxalate complex such as lithium bis[oxalate-O,O′]borate, lithium difluoro[oxalate-O,O′]borate, etc. Of those, especiallypreferred electrolyte salts are LiPF₆, LiBF₄, LiN(SO₂CF₃)₂, and LiN(SO₂C₂F₅)₂. Of those, most preferred electrolyte salts are LiPF₆, LiBF₄, and LiN(SO₂CF₃)₂. One or more of these electrolyte salts may be used herein either singly or as combined.

A preferred combination of these electrolyte salts is a combination containing LiPF₆ and further containing a lithium salt that contains a nitrogen atom or a boron atom. As the lithium salt that contains a nitrogen atom or a boron atom, at least one kind selected from LiBF₄, LiN(SO₂CF₃)₂ and LiN(SO₂C₂F₅)₂ is preferred. Even more preferred combinations include a combination of LiPF₆ and LiBF₄; a combination of LiPF₆ and LiN(SO₂CF₃)₂; a combination of LiPF₆ and LiN(SO₂C₂F₅)₂, etc.

When the molar ratio (LiPF₆:electrolyte salt selected from LiBF₄, LiN(SO₂CF₃)₂, and LiN(SO₂C₂F₅)₂) is smaller than 70:30 in point of the proportion of LiPF₆, or when the ratio is larger than 99:1 in point of the proportion of LiPF₆, then the high-temperature cycle property or the suppressing effect on the generation of a gas during charged battery storing may worsen. Accordingly, the molar ratio (LiPF₆:electrolyte salt selected from LiBF₄, LiN(SO₂CF₃)₂, and LiN(SO₂C₂F₅)₂) is preferably within a range of from 70:30 to 99:1, more preferably from 80:20 to 98:2. The combination falling within the above range is more effective for improving the high-temperature cycle property or the suppressing effect on the generation of a gas during charged battery storing.

The electrolyte salts can each be mixed at an arbitrary ratio. However, when a ratio (by mol) of the other electrolyte salts except LiBF₄, LiN(SO₂CF₃)₂, and LiN(SO₂C₂F₅)₂ to all the electrolyte salts in the case where LiPF₆ is used in combination with those ingredients is less than 0.01%, the high-temperature cycle property and the suppressing effect on the generation of a gas during charged battery storing are poor. When the ratio exceeds 45%, the high-temperature cycle property may worsen. Therefore, the ratio (by mol) is preferably from 0.01 to 45%, more preferably from 0.03 to 20%, still more preferably from 0.05 to 10%, and most preferably from 0.05 to 5%.

The concentration of all these electrolyte salts as dissolved in the solution is generally preferably at least 0.3 M relative to the above-mentioned nonaqueous solvent, more preferably at least 0.5 M, most preferably at least 0.7 M. The upper limit of the concentration is preferably at most 2.5 M, more preferably at most 2.0 M, even more preferably at most 1.5 M, most preferably at most 1.2 M.

As the electrolyte for electric double layer capacitors (condensers), usable are known quaternary ammonium salts such as tetraethylammonium tetrafluoroborate, triethylmethylammonium tetrafluoroborate, tetraethylammonium hexafluorophosphate, etc.

[Production of Nonaqueous Electrolytic Solution]

The nonaqueous electrolytic solution of the present invention can be prepared, for example, by: mixing the nonaqueous solvents; adding the electrolyte salt to the mixture; and adding the fluorine-containing phenol represented by the general formula (I) so that the content of the fluorine-containing phenol in the nonaqueous electrolytic solution may be from 0.01 to 3% by mass.

In this case, the nonaqueous solvent to be used, and the compound to be added to the electrolytic solution are preferably previously purified within a range not significantly detracting from the producibility, in which, therefore, the impurity content is preferably as low as possible.

The incorporation of, for example, air or carbon dioxide into the nonaqueous electrolytic solution of the present invention can additionally improve the high-temperature cycle property and the suppressing effect on the generation of a gas during charged battery storing.

In the present invention, an electrolytic solution prepared by dissolving carbon dioxide in the nonaqueous electrolytic solution is particularly preferably used from the viewpoints of improvements in charging and discharging properties at high temperatures. Carbon dioxide is dissolved in an amount of preferably 0.001% by mass or more, more preferably 0.05% by mass or more, and still more preferably 0.2% by mass or more with respect to the mass of the nonaqueous electrolytic solution. Carbon dioxide is most preferably dissolved in the nonaqueous electrolytic solution until the resultant solution saturates.

The nonaqueous electrolytic solution of the present invention is favorably used for the electrolytic solution for lithium primary batteries and lithium secondary batteries. Further, the nonaqueous electrolytic solution of the present invention is also usable as an electrolytic solution for electric double layer capacitors or as an electrolytic solution for hybrid capacitors. Of those, the nonaqueous electrolytic solution of the present invention is most favorable for lithium secondary batteries.

[Lithium Battery]

The lithium battery of the present invention collectively means a lithium primary battery and a lithium secondary battery, including the nonaqueous electrolytic solution of an electrolyte salt dissolved in a nonaqueous solvent, and is characterized in that the nonaqueous electrolytic solution contains the fluorine-containing phenol represented by the above-mentioned general formula (I) in an amount of from 0.01 to 3% by mass of the solution. As described above, the content of the fluorine-containing phenol in the nonaqueous electrolytic solution is preferably from 0.03 to 2% by mass, more preferably from 0.05 to 1.5% by mass, and still more preferably from 0.1 to 0.5% by mass.

In the lithium battery of the present invention, the other constitutive components such as the positive electrode and the negative electrode except for the nonaqueous electrolytic solution can be used with no particular limitation.

For example, one or more kinds selected from lithium complex metal oxides and lithium-containing olivine-type phosphates can each be used as a positive electrode active material for a lithium secondary battery. One kind of those positive electrode active materials can be used alone, or two or more kinds of them can be used in combination.

The lithium complex metal oxide preferably contains one or more kinds selected from cobalt, manganese, or nickel. Specific examples thereof include LiCoO₂, LiMn₂O₄, LiNiO₂, LiCO₁₋ₓNiₓO₂ (0.01<x<1), LiCO_{1/3}Ni_{1/3}Mn_{1/3}O₂, LiNi_{1/2}Mn_{3/2}O₄, LiCO_{0.98}Mg_{0.02}O₂, etc. Combinations of LiCoO₂ and LiMn₂O₄; LiCoO₂ and LiNiO₂; LiMn₂O₄ and LiNiO₂ are acceptable herein.

Further, for enhancing the safety in overcharging or enhancing the cycle property, the lithium complex metal oxide may be partly substituted with any other element for enabling the use of the battery at a charging potential of 4.3 V or more. For example, a part of cobalt, manganese and nickel may be substituted with at least one element of Sn, Mg, Fe, Ti, Al, Zr, Cr, V, Ga, Zn, Cu, Bi, Mo, La, etc.; or O may be partly substituted with S or F; or the oxide containing such other element may be coated.

Of those, preferred are lithium complex metal oxides such as LiCoO₂, LiMn₂O₄, and LiNiO₂, with which the positive electrode charging potential in a fully-charged state may be 4.3 V or more, based on Li. More preferred are lithium complex metal oxides usable at 4.4 V or more, such as LiCO₁₋ₓMₓO₂ (where M represents at least one element of Sn, Mg, Fe, Ti, Al, Zr, Cr, V, Ga, Zn, and Cu; 0.001≦x≦0.05), LiCO_{1/3}Ni_{1/3}Mn_{1/3}O₂, and LiNi_{1/2}Mn_{3/2}O₄. When a lithium complex metal oxide having a high charging voltage is used, the high-temperature cycle property and the suppressing effect on the generation of a gas during charged battery storing are apt to worsen owing to a reaction with the nonaqueous electrolytic solution during charging. In the lithium secondary battery according to the present invention, however, the deteriorations of those battery characteristics can be suppressed.

Further, as the lithium-containing olivine-type phosphate particularly preferably contains one or more kinds selected from Fe, Co, Ni, Mn, etc. Specific examples thereof include LiFePO₄, LiCoPO₄, LiNiPO₄, LiMnPO₄, etc.

The lithium-containing olivine-type phosphates may be partly substituted with any other element. For example, a part of iron, cobalt, nickel, and manganese therein may be substituted with at least one element selected from Co, Mn, Ni, Mg, Al, B, Ti, V, Nb, Cu, Zn, Mo, Ca, Sr, W, and Zr; or the phosphates may be coated with a compound containing any of these other elements or with a carbon material. Of those, preferred are LiFePO₄ and LiMnPO₄.

Further, the lithium-containing olivine-type phosphate may be combined with, for example, the above-mentioned positive electrode active materials.

Further, for the positive electrode for lithium primary battery, there are mentioned oxides or chalcogen compounds of one or more metal elements such as CuO, Cu₂O, Ag₂O, Ag₂CrO₄, CuS, CuSO₄, TiO₂, TiS₂, SiO₂, SnO, V₂O₅, V₆O₁₂, VOₓ, Nb₂O₅, Bi₂O₂, Bi₂Pb₂O₅, Sb₂O₃, CrO₃, MoO₃, WO₃, SeO₂, MnO₂, Mn₂O₃, Fe₂O₃, FeO, Fe₃O₄, Ni₂O₃, NiO, CoO₃, CoO, etc.; sulfur compounds such as SO₂, SOCl₂, etc.; carbon fluorides (graphite fluoride) represented by a general formula (CFₓ)ₙ, etc. Of those, preferred are MnO₂, V₂O₅, graphite fluoride, etc.

The case where the pH of a supernatant when 10 g of the above-mentioned positive electrode active material are dispersed in 100 ml of distilled water is from 10.0 to 12.5 is preferred because the high-temperature cycle property and the suppressing effect on the generation of a gas during charged battery storing are obtained with additional ease, and the case where the pH is from 10.5 to 12.0 is more preferred.

In addition, the case where the positive electrode contains Ni as an element is preferred because of the following reason. Since the amount of impurities such as LiOH in the positive electrode active material tends to increase, the high-temperature cycle property and the suppressing effect on the generation of a gas during charged battery storing are obtained with additional ease. The case where the atomic concentration of Ni in the positive electrode active material is from 5 to 25 atomic % is more preferred, and the case where the atomic concentration is from 8 to 21 atomic % is still more preferred.

Not specifically defined, the electroconductive agent of the positive electrode may be any electron-transmitting material not undergoing chemical change. For example, it includes graphites such as natural graphite (flaky graphite, etc.), artificial graphite, etc.; carbon blacks such as acetylene black, Ketjen black, channel black, furnace black, lamp black, thermal black, etc. Graphites and carbon blacks may be combined suitably. The amount of the electroconductive agent to be added to the positive electrode mixture is preferably from 1 to 10% by mass, more preferably from 2 to 5% by mass.

The positive electrode may be produced by mixing the above-mentioned positive electrode active material with an electroconductive agent such as acetylene black, carbon black or the like, and with a binder such as polytetrafluoroethylene (PTFE), polyvinylidene fluoride (PVDF), styrene/butadiene copolymer (SBR), acrylonitrile/butadiene copolymer (NBR), carboxymethyl cellulose (CMC), ethylene/propylene/diene terpolymer or the like, then adding thereto a high-boiling-point solvent such as 1-methyl-2-pyrrolidone or the like, and kneading them to give a positive electrode mixture, thereafter applying the positive electrode mixture onto an aluminium foil or a stainless lath plate or the like serving as a collector, and drying and shaping it under pressure, and then heat-treating it in vacuum at a temperature of from 50° C. to 250° C. or so for about 2 hours.

The density of the part except the collector of the positive electrode may be generally at least 1.5 g/cm³, and for further increasing the capacity of the battery, the density is preferably at least 2 g/cm³, more preferably at least 3 g/cm³, even more preferably at least 3.6 g/cm³. When more than 4.0 g/cm³, however, the production may be substantially difficult, and therefore, the upper limit is preferably at most 4.0 g/cm³.

As the negative electrode active material for a lithium secondary battery, usable are lithium metals, lithium alloys, and carbon materials capable of absorbing and releasing lithium.

Examples of the carbon material capable of absorbing and releasing lithium include graphitizable carbon, non-graphitizable carbon having a (002) plane spacing of 0.37 nm or more, and graphite having a (002) plane spacing of 0.34 nm or less.

Of those, preferred is use of a high-crystalline carbon material such as artificial graphite or natural graphite in view of the ability thereof to absorb and release lithium ions, and even more preferred is use of a carbon material having a graphite crystal structure where the lattice (002) spacing (d002) is at most 0.340 nm (nanometers), especially from 0.335 to 0.337 nm.

Upon shaping of a negative electrode sheet, for example, when the negative electrode sheet is shaped under pressure by using artificial graphite particles (i) each having a massive structure in which a plurality of flat graphite-like fine particles are aggregated or bonded so as to be non-parallel to each other, or graphite particles (ii) obtained by subjecting flaky, natural graphite particles to a spheroidizing treatment through repeated application of a mechanical action such as a compressive force, a frictional force, or a shearing force so that the density of a part of the negative electrode except the collector may be 1.5 g/cm³, and a ratio [I(110)/I(004)] between a peak intensity I(110) of a (110) plane and a peak intensity I(004) of a (004) plane in the graphite crystal of the resultant negative electrode sheet by X-ray diffraction measurement is 0.01 or more, the negative electrode sheet is typically apt to react with the nonaqueous electrolytic solution during charging, and hence the battery characteristics such as the high-temperature cycle property may worsen. However, the electrolytic solution of the present invention is preferably used here because the above-mentioned effects are additionally improved. The ratio [I(110)/I(004)] is more preferably 0.05 or more and still more preferably 0.1 or more. In addition, an upper limit for the ratio [I(110)/I(004)] is preferably 0.5 or less and more preferably 0.3 or less because of the following reason. When the particles are excessively treated, the crystallinity reduces, and hence the discharge capacity of the battery may reduce.

In the lithium secondary battery according to the present invention, the reaction with the nonaqueous electrolytic solution can be suppressed. In addition, a high-crystalline carbon material is preferably coated with a low-crystalline carbon material because the decomposition of the nonaqueous electrolytic solution is additionally suppressed.

The metal compound capable of absorbing and releasing lithium, serving as a negative electrode active material, includes compounds containing at least one metal element of Si, Ge, Sn, Pb, P, Sb, Bi, Al, Ga, In, Ti, Mn, Fe, Co, Ni, Cu, Zn, Ag, Mg, Sr, Ba, etc. These metal compounds may have any morphology of simple substances, alloys, oxides, nitrides, sulfides, borides, alloys with lithium or the like; but preferred are any of simple substances, alloys, oxides, and alloys with lithium, as capable of increasing the battery capacity. Of those, more preferred are those containing at least one element selected from Si, Ge and Sn, and even more preferred are those containing at least one element selected from Si and Sn, as capable of increasing the capacity of the battery.

The negative electrode may be produced, using the same electroconductive agent, binder, and high-boiling point solvent as in the formation of the above-mentioned positive electrode. These are mixed and kneaded to give a negative electrode mixture, then the negative electrode mixture is applied onto a copper foil or the like serving as a collector, then dried and shaped under pressure, and thereafter heat-treated in vacuum at a temperature of from 50° C. to 250° C. or so for about 2 hours.

In the case where graphite is used as the negative electrode active material, the density of the part except the collector of the negative electrode is generally at least 1.4 g/cm³, and for further increasing the capacity of the battery, the density is preferably at least 1.6 g/cm³, more preferably at least 1.7 g/cm³. When more than 2.0 g/cm³, however, the production may be substantially difficult, and therefore, the upper limit is preferably at most 2.0 g/cm³.

As the negative electrode active material for a lithium primary battery, usable is a lithium metal or a lithium alloy.

The structure of the lithium secondary battery is not specifically defined. The battery may be a coin-shaped battery, a cylindrical battery, a square-shaped battery, a laminate-type battery or the like, each having a single-layered or multi-layered separator.

As the separator for a battery, usable is, with no particular limitation, a single-layer or laminate porous film of polyolefin such as polypropylene, polyethylene or the like, as well as a woven fabric, a nonwoven fabric, etc.

The lithium secondary battery in the present invention is excellent in high-temperature cycle property and suppressing effect on the generation of a gas during charged battery storing even when its final charging voltage is 4.2 V or more, in particular, 4.3 V or more. Further, those properties are good even when the final charging voltage is 4.4 V or more. Although a final discharging voltage can be typically 2.8 V or more, and furthermore, 2.5 V or more, the final discharging voltage of the lithium secondary battery in the present invention can be 2.0 V or more. Although a current value is not particularly limited, the lithium secondary battery is typically used in a range of 0.1 to 3 C. In addition, the lithium battery in the present invention can be charged and discharged at the range from −40 to 100° C. and preferably at the range from 0 to 80° C.

In the present invention, as a countermeasure against the increase in the internal pressure of the lithium battery, there may be employed a method of providing a safety valve in the battery cap or a method of forming a cutout in the battery component such as the battery can, the gasket or the like. In addition, as a safety countermeasure against overcharging, a current breaker capable of detecting the internal pressure of the battery to cut off the current may be provided in the battery cap.

### EXAMPLES

Hereinafter, examples in each of which the nonaqueous electrolytic solution of the present invention is used are described. However, the present invention is not limited to these examples.

### Examples 1 to 7 and Comparative Examples 1 to 3

### Production of Lithium Ion Secondary Battery

94 Percent by mass of LiNi_{1/3}Mn_{1/3}CO_{1/3}O₂ (positive electrode active material, the pH of a supernatant when 10 g of the positive electrode active material were dispersed in 100 ml of distilled water was 11.1) and 3% by mass of acetylene black (electroconductive agent) were mixed. The mixture was added to and mixed with a solution previously prepared by dissolving 3% by mass of polyvinylidene fluoride (binder) in 1-methyl-2-pyrrolidone. Thus, a positive electrode mixture paste was prepared.

The positive electrode mixture paste was applied to both surfaces on an aluminum foil (collector), dried, processed under pressure, and cut into a predetermined size. Thus, a long rectangular, positive electrode sheet was produced. The density of a part of the positive electrode except the collector was 3.6 g/cm³.

In addition, 95% by mass of artificial graphite (d₀₀₂=0.335 nm, negative electrode active material) was added to and mixed with a solution previously prepared by dissolving 5% by mass of polyvinylidene fluoride (binder) in 1-methyl-2-pyrrolidone. Thus, a negative electrode mixture paste was prepared. The negative electrode mixture paste was applied to both surfaces on a copper foil (collector), dried, processed under pressure, and cut into a predetermined size. Thus, a long rectangular, negative electrode sheet was produced. The density of apart of the negative electrode except the collector was 1.7 g/cm³.

Next, the positive electrode sheet, a porous polyethylene film separator, the negative electrode sheet, and a separator were laminated in that order, and the resulting laminate was coiled up. The coil was housed into a nickel-plated, iron-made cylindrical battery can serving also as a negative electrode terminal.

Further, a nonaqueous electrolytic solution that had been prepared by adding a predetermined amount of the compound described in Table 2 was injected into the battery can, which was caulked with a battery cap having a positive electrode terminal, via a gasket therebetween, thereby producing a 18650-type cylindrical battery. The positive electrode terminal was connected to the positive electrode sheet via an aluminium lead tab therebetween; and the negative electrode can was previously connected to the negative electrode sheet inside the battery, via a nickel lead tab therebetween.

The resultant battery was evaluated for its high-temperature cycle property and gas generation amount by the following methods. Table 2 shows the results.

### Evaluation for High-Temperature Cycle Property

The cylindrical battery produced by the above-mentioned method was charged in a thermostat chamber at 60° C. to a final voltage of 4.2 V for 3 hours at a constant current of 1 C and a constant voltage. Next, the battery was discharged to a final voltage of 2.75 V under a constant current of 1 C. The foregoing operation was defined as one cycle, and the operation was repeated until the number of cycles reached 100. Then, a discharge capacity retention rate after the 100 cycles was determined from the following equation.

Discharge Capacity Retention Rate(%)=[discharge capacity in 100-th cycle/discharge capacity in first cycle]×100

### Evaluation for Gas Generation Amount

Another cylindrical battery using an electrolytic solution having the same composition as that described above was charged in a thermostat chamber at 25° C. to a final voltage of 4.2 V for 7 hours at a constant current of 0.2 C and a constant voltage. Then, the battery was placed in a thermostat chamber at 85° C. and stored for 7 days in an open-circuit state. After that, a gas generation amount was measured by Archimedes' method. The gas generation amount was determined as a relative value when the gas generation amount of Comparative Example 1 was defined as 100%.

TABLE 2

| | Composition of | | | | Gas generation |
|---|---|---|---|---|---|
| | electrolyte salt | | | Discharge | amount after |
| | Composition of nonaqueous | | Addition amount | capacity | charged |
| | electrolytic solution | | (content in nonaqueous | retention rate | battery |
| | (volume ratio between | | electrolytic solution) | after 100 cycles | storing |
| | solvents) | Compound | (% by mass) | (%) | (%) |
| Example 1 | 1M LiPF6 | Pentafluorophenol | 0.05 | 77 | 87 |
| | EC/VC/DEC | | | | |
| | (28/2/70) | | | | |
| Example 2 | 1M LiPF6 | Pentafluorophenol | 0.3 | 83 | 82 |
| | EC/VC/DEC | | | | |
| | (28/2/70) | | | | |
| Example 3 | 1M LiPF6 | Pentafluorophenol | 1 | 81 | 85 |
| | EC/VC/DEC | | | | |
| | (28/2/70) | | | | |
| Example 4 | 1M LiPF6 | 2,3,5,6-Tetrafluorophenol | 0.3 | 82 | 84 |
| | EC/VC/DEC | | | | |
| | (28/2/70) | | | | |
| Example 5 | 1M LiPF6 | 2,3,4-Trifluorophenol | 0.3 | 80 | 87 |
| | EC/VC/DEC | | | | |
| | (28/2/70) | | | | |
| Example 6 | 1M LiPF6 | Pentafluorophenol | 0.3 | 85 | 81 |
| | EC/VC/MEC/DEC | | | | |
| | (28/2/40/30) + | | | | |
| | PS (1 wt %) | | | | |
| Example 7 | 0.95M LiPF6 + | Pentafluorophenol | 0.3 | 87 | 80 |
| | 0.05M LiN(SO2CF3)2 | | | | |
| | FEC/EC/VC/DMC/DEC | | | | |
| | (23/5/2/40/30) | | | | |
| Comparative | 1M LiPF6 | None | — | 72 | 100 |
| Example 1 | EC/VC/DEC | | | | |
| | (28/2/70) | | | | |
| Comparative | 1M LiPF6 | 2,4-Difluorophenol | 0.3 | 71 | 95 |
| Example 2 | EC/VC/DEC | | | | |
| | (28/2/70) | | | | |
| Comparative | 1M LiPF6 | Pentachlorophenol | 0.3 | 62 | 93 |
| Example 3 | EC/VC/DEC | | | | |
| | (28/2/70) | | | | |

### Example 8 and Comparative Example 4

A negative electrode sheet was produced, using Si (negative electrode active material) in place of artificial graphite (negative electrode active material) used in each of Example 2 and Comparative Example 1. 80 Percent by mass of Si and 15% by mass of acetylene black (electroconductive agent) were mixed, and added to and mixed with a solution previously prepared by dissolving 5% by mass of polyvinylidene fluoride (binder) in 1-methyl-2-pyrrolidone, thereby preparing a negative electrode mixture paste.

A cylindrical battery was produced in the same manner as in each of Example 2 and Comparative Example 1 except that the above negative electrode mixture paste was applied onto a copper foil (collector), dried, processed under pressure, and cut into a predetermined size, thereby producing a long rectangular, negative electrode sheet; and the battery was evaluated. The results are shown in Table 3.

TABLE 3

| | Composition of | | | | Gas generation |
|---|---|---|---|---|---|
| | electrolyte salt | | | Discharge | amount after |
| | Composition of nonaqueous | | Addition amount | capacity | charged |
| | electrolytic solution | | (content in nonaqueous | retention rate | battery |
| | (volume ratio between | | electrolytic solution) | after 100 cycles | storing |
| | solvents) | Compound | (% by mass) | (%) | (%) |
| Example 8 | 1M LiPF6 | Pentafluorophenol | 0.3 | 71 | 86 |
| | EC/VC/DEC | | | | |
| | (28/2/70) | | | | |
| Comparative | 1M LiPF6 | None | — | 31 | 100 |
| Example 4 | EC/VC/DEC | | | | |
| | (28/2/70) | | | | |

### Example 9 and Comparative Example 5

A positive electrode sheet was produced, using LiFePO₄ (positive electrode active material) in place of LiNi_{1/3}Mn_{1/3}Co_{1/3}O₂ (positive electrode active material) used in each of Example 2 and Comparative Example 1. 90 Percent by mass of LiFePO₄ and 5% by mass of acetylene black (electroconductive agent) were mixed, and added to and mixed with a solution previously prepared by dissolving 5% by mass of polyvinylidene fluoride (binder) in 1-methyl-2-pyrrolidone, thereby preparing a positive electrode mixture paste.

A cylindrical battery was produced in the same manner as in each of Example 2 and Comparative Example 1 except that the positive electrode mixture paste was applied onto an aluminium foil (collector), dried, processed under pressure, and cut into a predetermined size, thereby producing a long rectangular, positive electrode sheet, the final charging voltage was 3.6 V in each of the evaluation for cycle property and the evaluation for the gas generation amount, and the final discharging voltage was 2.0 V; and the battery was evaluated. The results are shown in Table 4.

TABLE 4

| | Composition of | | | | Gas generation |
|---|---|---|---|---|---|
| | electrolyte salt | | | Discharge | amount after |
| | Composition of nonaqueous | | Addition amount | capacity | charged |
| | electrolytic solution | | (content in nonaqueous | retention rate | battery |
| | (volume ratio between | | electrolytic solution) | after 100 cycles | storing |
| | solvents) | Compound | (% by mass) | (%) | (%) |
| Example 9 | 1M LiPF6 | Pentafluorophenol | 0.3 | 86 | 87 |
| | EC/VC/DEC | | | | |
| | (28/2/70) | | | | |
| Comparative | 1M LiPF6 | None | — | 74 | 100 |
| Example 5 | EC/VC/DEC | | | | |
| | (28/2/70) | | | | |

The lithium secondary batteries of Examples 1 to 7 described above (to each of which phenol 3 to 5 hydrogen atoms of which were substituted with fluorine was added) each showed significant improvements in high-temperature cycle property and suppressing effect on the generation of a gas during charged battery storing as compared with the lithium secondary batteries of Comparative Example 1 (to which no compound was added), Comparative Example 2 (to which 2,4-difluorophenol obtained by substituting 2 hydrogen atoms of phenol with fluorine was added), and Comparative Example 3 (to which pentachlorophenol obtained by substituting 5 hydrogen atoms of phenol with chlorine was added). The foregoing shows that the effect of the present invention is specific to the case where the nonaqueous electrolytic solution contains phenol 3 or more hydrogen atoms of the benzene ring of which are substituted with fluorine, and is specific to the case where a halogen element with which a hydrogen atom is substituted is fluorine.

Comparison between Example 8 and Comparative Example 4 shows that a similar effect is observed even when Si is used in a negative electrode. In addition, comparison between Example 9 and Comparative Example 5 shows that a similar effect is observed even when a lithium-containing olivine-type iron phosphate is used in a positive electrode. Accordingly, it is clear that the effect of the present invention is not an effect dependent on a specific positive electrode or negative electrode.

Further, the nonaqueous electrolytic solution of the present invention has an improving effect on the high-temperature storage property of a lithium primary battery.

### INDUSTRIAL APPLICABILITY

The lithium battery using the nonaqueous electrolytic solution of the present invention is very useful because the battery is excellent in high-temperature cycle property and in the suppressing effect on the generation of a gas during charged battery storing.

1. A nonaqueous electrolytic solution comprising an electrolyte salt dissolved in a nonaqueous solvent, which further comprises a fluorine-containing phenol represented by the following formula (I) in an amount of from 0.01 to 3% by mass of the nonaqueous electrolytic solution: 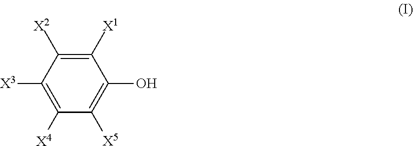
wherein X¹ to X⁵ each independently represent a fluorine atom or a hydrogen atom, and 3 to 5 thereof represent fluorine atoms.

2. The nonaqueous electrolytic solution according to claim 1, wherein the fluorine-containing phenol represented by the general formula (I) has a fluorine atom at an ortho-position and/or a para-position.

3. The nonaqueous electrolytic solution according to claim 1, wherein the fluorine-containing phenol represented by the general formula (I) comprises tetrafluorophenol and/or pentafluorophenol.

4. The nonaqueous electrolytic solution according to claim 1, wherein the nonaqueous solvent comprises a cyclic carbonate and a linear carbonate.

5. The nonaqueous electrolytic solution according to claim 4, wherein the linear carbonate comprises a symmetric linear carbonate and an asymmetric linear carbonate.

6. The nonaqueous electrolytic solution according to claim 4, wherein the linear carbonate comprises diethyl carbonate.

7. The nonaqueous electrolytic solution according to claim 4, wherein the cyclic carbonate comprises ethylene carbonate and/or propylene carbonate, and a cyclic carbonate comprising a double bond or fluorine.

8. The nonaqueous electrolytic solution according to claim 4, wherein the linear carbonate comprises at least one asymmetric linear carbonate selected from the group consisting of methyl ethyl carbonate, methyl propyl carbonate, and methyl butyl carbonate.

9. The nonaqueous electrolytic solution according to claim 1, wherein the electrolyte salt comprises at least one compound selected from the group consisting of LiPF₆, LiBF₄, LiN(SO₂CF₃)₂, and LiN(SO₂C₂F₅)₂.

10. The nonaqueous electrolytic solution according to claim 1, wherein the electrolyte salt comprises LiPF₆, and the electrolyte salt further comprises a second compound selected from the group consisting of LiBF₄, LiN(SO₂CF₃)₂, and LiN(SO₂C₂F₅)₂ wherein the ratio of LiPF₆ to the second compound falls within a range of from 70:30 to 99:1.

11. A lithium battery, comprising:
a positive electrode;
a negative electrode; and
a nonaqueous electrolytic solution prepared by dissolving an electrolyte salt in a nonaqueous solvent,
wherein the nonaqueous electrolytic solution comprises the fluorine-containing phenol represented by the general formula (I) in an amount of from 0.01 to 3% by mass of the nonaqueous electrolytic solution.

12. The lithium battery according to claim 11, wherein the positive electrode comprises at least one positive electrode active material selected from the group consisting of a lithium complex metal oxide and a lithium-containing olivine-type phosphate.

13. The lithium battery according to claim 11, wherein the negative electrode comprises at least one negative electrode active material selected from the group consisting of a lithium metal, a lithium alloy, a high-crystalline carbon material capable of absorbing and releasing lithium, and a metal compound capable of absorbing and releasing lithium.
